(19) United States
(12) Patent Application Publication
(10) Pub. No.: US 2016/0353138 A1
(43) Pub. Date: Dec. 1, 2016

(54) SELECTIVE ENCODING AND TRANSMISSION OF ADAPTIVE BITRATE VIDEO THROUGH NON REFERENCE VIDEO QUALITY ANALYSIS

(71) Applicant: CHEETAH TECHNOLOGIES, L.P. d/b/a V-FACTOR TECHNOLOGIES, Pittsburgh, PA (US)

(72) Inventor: JEREMY BENNINGTON, GREENWOOD, IN (US)

(73) Assignee: CHEETAH TECHNOLOGIES, L.P. d/b/a V-FACTOR TECHNOLOGIES, PITTSBURGH, PA (US)

(21) Appl. No.: 15/166,887

(22) Filed: May 27, 2016

Related U.S. Application Data
(60) Provisional application No. 62/167,478, filed on May 28, 2015.

(51) Int. Cl. H04N 21/234; H04N 21/435; H04N 21/61

(52) U.S. Cl. CPC H04N 21/23418; H04N 21/6125; H04N 21/4358

(57) ABSTRACT

A method of managing video signals utilizes non-reference quality analysis to select versions of the video which are of at least a desired quality to process and distribute from among versions which are not of a desired quality.

### CROSS REFERENCE TO RELATED APPLICATION

This application claims the benefit of U.S. Provisional Patent Application Ser. No. 62/167,478, filed May 28, 2015, which is incorporated by reference herein.

### BACKGROUND OF THE INVENTION

### 1. Field of the Invention

The present invention pertains to systems and methods for managing the transmission and processing of video signals.

### 2. Description of the Related Art

Video quality can be measured using several different algorithmic methods. Some methods compare a reference video to a video that has been processed in some way to look for degradations, this is commonly referred to as a full-reference or partial reference analysis. In contrast, a non-reference analysis has no reference video to make comparisons to. Instead, a non-reference analysis uses algorithmic models to model the human vision system and identify video artifacts that would be perceivable by the human eye. The various artifacts are commonly aggregated to generate a Mean Opinion Score (MOS) that is used to “rate” the video quality on a 1-5 scale. An example of such a scale is shown in the table provided in FIG. 1 (sourced from ITU-R BT.500-13).

While full-reference and partial reference models are useful in laboratory environments when testing devices to determine their impacts on video quality, such models are generally not practical in an operational network. In an operational network, video is received from a third party. As an example, Comcast is a network operator which receives video from HBO, a content provider. The quality of video received by a network operator from a content provider is unknown and there is no reference video for the network operator to measure and compare the received video against. In this case, if the network operator wants to determine the quality or artifacts in the third party video, they must use a non-reference measurement. Some examples of non-reference measurement techniques are described in Appendices A-C attached hereto, the contents of which are incorporated by reference herein.

Historically, a network operator would engineer a single video distribution path for each channel and do their best to maintain the quality that was received. Knowing the quality was helpful in solving support questions, but very few operational decisions would be made based on quality. In newer networks where network operators utilize Adaptive Bitrate (ABR) services, a single video distribution path is no longer utilized. Instead they have several versions of the same video content encoded at different bitrates that are distributed across their network or the Internet. When a user chooses to watch an ABR service, the highest bitrate is used and is constantly adjusted based on the network bandwidth available to the user. One of the challenges in such method is that each version of the video has a different quality. The quality of the video is primarily impacted by the quality of the “source” video that the operator receives and the encoded/compressed quality based on the bitrate chosen for each version of the video for ABR.

Without being able to monitor the quality of the source or the compressed version of the video, the operator is transmitting video of unknown quality and thus does not know what, if any, impact their compression has on the video. Such arrangement may be hugely wasteful of encoding and network resources as if the video quality is poor, end users will likely not want to watch it, thus making the transmission a waste of resources.

Accordingly, there is room for improvement in systems and methods for managing the transmission and processing of video signals.

### SUMMARY OF THE INVENTION

As one embodiment of the disclosed concept, a method of managing one or more of the transmission and processing of video signals is provided. The method comprises: receiving a source video; determining the perceptual video quality of the source video by performing a non-reference quality analysis on the source video; determining one of: that the perceptual video quality of the source video is below a first predetermined threshold, that the perceptual video quality of the source video is at least the first predetermined threshold but less than a second predetermined threshold, or that the perceptual video quality of the source video is at least the second predetermined threshold; and in response to said determining: compressing a plurality of versions of the source video in accordance with a plurality of corresponding profiles if it is determined that the quality of the source video is at least the second predetermined threshold, compressing a number of versions of the source video in accordance with a number of corresponding profiles if it is determined that the quality of the source video is at least the first predetermined threshold but less than the second predetermined threshold, wherein the number of copies is less than the plurality of copies, or performing no compression of the source video if it is determined that the quality of the source video is below a first predetermined threshold.

The method may further comprise performing another non-reference quality analysis on at least one version of the compressed versions of the source video.

The method may further comprise determining that the perceptual video quality of the at least one version of the compressed versions of the source video is at least a third threshold and responsive thereto indicating that the at least one version is acceptable to distribute.

Indicating that the at least one version is acceptable to distribute may comprise communicating the at least one version to a distributer.

Indicating that the at least one version is acceptable to distribute may comprise distributing the at least one version to an end consumer.

The method may further comprise determining that the perceptual video quality of the at least one version of the compressed versions of the source video is less than a third threshold and responsive thereto performing no further processing of the at least one version.

The method may further comprise performing another non-reference quality analysis on at least two versions of the compressed versions of the source video.

The method may further comprise determining that the perceptual video quality of the at least two versions of the compressed versions of the source video are at least a third threshold and are within a predetermined percentage of each other, and responsive thereto, selecting only one of the at least two versions to distribute.

Selecting only one of the at least two versions to distribute may comprise selecting the version of the at least two versions having a lower bit rate associated therewith.

Selecting the one version to distribute may comprise communicating the one version to a distributer.

Selecting the one version to distribute may comprise distributing the at least one version to an end consumer.

### BRIEF DESCRIPTION OF THE DRAWING

FIG. 1 is a table showing an example Mean Opinion Score (MOS) scale that is used to “rate” video quality on a 1-5 scale.

FIG. 2 is a flow chart showing a method in accordance with an example embodiment of the disclosed concept.

### DETAILED DESCRIPTION OF EXEMPLARY EMBODIMENTS

As used herein, the singular form of “a”, “an”, and “the” include plural references unless the context clearly dictates otherwise.

As employed herein, the term “number” shall mean one or an integer greater than one (i.e., a plurality).

The present invention will now be described, for purposes of explanation, in connection with numerous specific details in order to provide a thorough understanding of the subject invention. It will be evident, however, that the present invention can be practiced without these specific details without departing from the spirit and scope of this innovation.

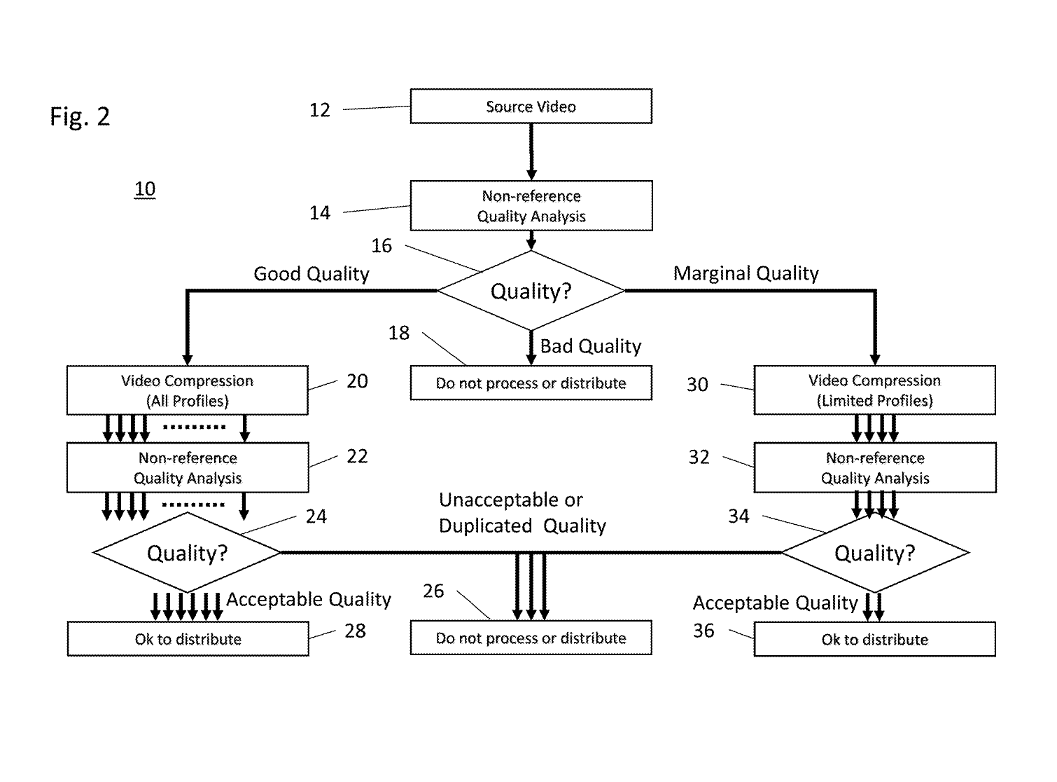

In reference to FIG. 2, an example embodiment of a method 10 in accordance with the disclosed concept will now be described. Method 10 begins at 12 when a source video of unknown quality is received. The source video is initially subjected to a non-reference quality analysis at 14, such that an operator can measure the perceptual video quality of the source video. Such non-reference quality analysis is carried out by decoding the source video. An example of a suitable non-reference quality analysis which may be employed in accordance with the disclose concept is described in—“Video Quality Evaluation for Internet Streaming Applications” by Stefan Winkler and Ruth Campos, Audiovisual Communications Laboratory and Signal Processing Laboratory Swiss Federal Institute of Technology (EPFL), 1015 Lausanne, Switzerland—the contents of which is incorporated by reference herein. Another example of a suitable non-reference quality analysis which may be employed was described in the presentation—“no reference video quality assessment metrics for multimedia: state of the art of signal-based approaches”, Orange Labs, Nicolas Ramin, Ricardo Pastrana-Vidal, Université de Nantes—France—presented at the “Effect of transmission performance on Multimedia Quality of Service”, 17-19 Jun. 2008, Prague, Czec Republic, the contents of which is incorporated by reference herein. It is to be appreciated, however, that other suitable non-reference quality analysis approaches may be employed without varying from the scope of the disclosed concept.

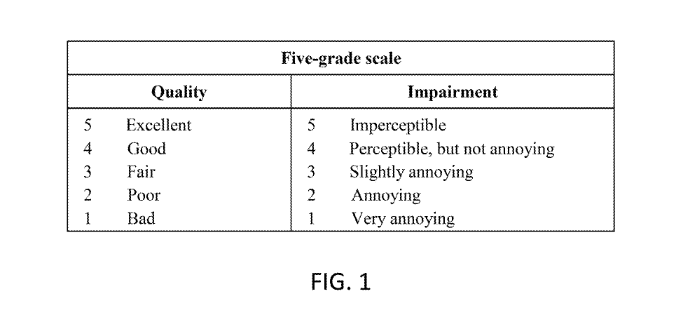

Next, as shown at 16, if after performing the non-reference quality analysis at 14 it is determined that the quality of the source video is below a predetermined first threshold, and thus is what the operator considers to be of “bad” quality, the decision is made to not process or distribute the source video, such as shown at 18. In doing so, the operator reduces/eliminates the cost of processing and transmitting video that is effectively unwatchable. For example, without limitation, an MOS scale such as the example shown in FIG. 1 may be employed for “scoring” the quality of the source video. In an example embodiment, the first threshold might be set at “3” (i.e., “Fair”) depending on the desired end video quality for the particular application.

If, after performing the non-reference quality analysis at 14, it is determined (at 16) that the quality of the source video is of at least a predetermined second threshold (e.g., without limitation, a “4” on the scale shown in FIG. 1) greater than the aforementioned first threshold, and thus is of at least “Good” quality, the operator then processes (i.e., compresses) a plurality of versions of the source video (as shown at 20) at a plurality of different bit rates in accordance with a plurality of corresponding profiles (i.e., each version is compressed at a different bit rate). As the source video in such instance is of at least “Good” quality, there is a high likelihood that low bit rate versions of the source video will be of acceptable quality and thus are compressed along with higher bit rate versions. Depending on the application, the plurality of profiles typically is in the range of 4-12 profiles. However, other quantities of profiles may be employed without varying from the scope of the disclosed concept.

As shown at 22, after the source video has been compressed in the various versions in accordance with the different profiles at 20, another non-reference quality analysis is performed on each of the compressed versions by decoding each version to ensure that quality of at least a predetermined third threshold is obtained. In example embodiments of the disclosed concept, such third threshold value is typically greater than the first threshold value and less than the second threshold value as some reduction in video quality is anticipated due to processing operations. Accordingly, referring once again to the previously mentioned example, such third threshold might be set at “3.5” (i.e., between “Fair” and “Good” on the scale shown in FIG. 1) depending on the application.

If it is determined at 24 that the measured quality of a particular compressed version is less than the predetermined third value (i.e., measured quality is not at least at a desired level, and thus the source video would not be desirable to view if distributed in accordance with such corresponding profile), the decision is made to not further process or distribute the video in accordance with such profile (such as shown at 26). Otherwise, if at 24 it is determined that the measured quality of the compressed version is at least the predetermined third threshold value (i.e., measured quality is at least a desired level), the video is then deemed to be acceptable for distribution (in accordance with such profile) to customers, such as shown at 28, and thus is communicated/transmitted through appropriate means for such distribution to customers. If at 24 two or more acceptable versions of the source video are found to be of the same, or essentially the same, quality (i.e., have the same measured quality or have measured qualities within a predetermined % of each other, e.g., without limitation, 5%), then the version compressed at the profile having a lower bit rate is selected for distribution and any other version or versions at a profile with a higher bit rate are selected to not be further processed or distributed.

If, after performing the non-reference quality analysis at 14, it is determined (in step 16) that the quality of the source video is at least the first threshold but less than the second threshold, and thus is of a “marginal quality” (i.e., better than the predetermined “bad” quality but less than the predetermined “good” quality), the operator then processes (i.e., compresses) the source video (as shown at 30) at a number of different bit rates in accordance with a number of corresponding profiles. In such case the number of compressed versions is less than the plurality of compressed copies discussed in the previous case since the source video was previously determined (in 16) to be generally only of “marginal quality” and thus the compressed version thereof would likely only be of acceptable quality at generally high bit rates (and thus lower bit rate versions are not considered).

As shown at 32, after the source video has been compressed in the various versions in accordance with the different profiles at 30, another non-reference quality analysis is performed on each of the compressed versions by decoding each version to ensure that quality of at least the predetermined third threshold is obtained. If it is determined at 34 that the measured quality of a particular compressed version is less than the predetermined third value (i.e., measured quality is not at least at a desired level, and thus the video would not be desirable to view), the decision is made to not further process or distribute the video in accordance with such profile (such as shown at 26). Otherwise, if at 34 it is determined that the measured quality of the compressed version is at least the predetermined third threshold value (i.e., measured quality is at least a desired level), the video is then deemed to be acceptable for distribution (in accordance with such profile) to customers, such as shown at 36, and thus is passed on through appropriate channels for such distribution to customers. If at 34 two or more acceptable versions of the source video are found to be of the same, or essentially the same, quality (i.e., have the same measured quality or have measured qualities within a predetermined % of each other, e.g., without limitation, 5%), then the version compressed at the profile having a lower bit rate is selected for distribution and any other version or versions at a profile with a higher bit rate are not further processed or distributed.

As an example, if the operator sees marginal quality they may decide that only the high bitrate profiles will be able to maintain the marginal quality and that the lower bitrate profiles will produce really poor quality and therefore should not be created or distributed. Alternately, the operator may decide for similar reasons that only the profiles in the middle of the bandwidth range should be used because they do not want to waste bandwidth on the high bitrate profiles when it will be marginal at best, or no quality gain will be seen.

After acceptable versions of the source video have been identified at either 28 or 36, such versions may be directly distributed, in accordance with the corresponding profiles thereof, to end consumers of the source video or such versions may be passed on to distributers for subsequent distribution thereof.

By using non-reference video quality analysis in a manner as described herein, a network operator can selectively encode and transmit their ABR video based on the quality of the video. If the quality is acceptable, the operator can process and transmit the video and maintain a known video quality for their customers. If the quality is unacceptable for all or some of the video, the operator can selectively choose not to encode or transmit the video. By not transmitting the poor quality video, the operator can save not just encoding/compression resources, but also valuable network bandwidth.

There are applications of using video quality monitoring as a pre-processing step prior to compression to improve video quality and reduce bitrate of a compressed video. However, in such applications the video is always compressed and transmitted, regardless of the result of the quality monitoring. This is in contrast to embodiments of the present concept in which compression and transmission is selectively stopped entirely based on the result of quality monitoring.

There are applications of using bandwidth measurement to change encoding parameters to optimize the ABR video for the available bandwidth. However, such applications do not employ non-reference quality measurement whatsoever, and thus have a number of disadvantages as compared to the disclosed concept. A disadvantage of this approach is that by making the bandwidth of each profile dynamic, the quality becomes highly variable. It also goes against the basic framework of ABR video where you create several profiles of video and let the thousands of clients choose which profile to use based on bandwidth. Accordingly, by changing one of the profiles in such applications, the stream to that one client is not only affected, but instead the stream to all clients using that profile is affected.

It is to be appreciated that the method described herein may be carried out at one or more locations utilizing one or more systems. Presently, such method is performed in a single location. The analysis is done on one system and the compression (performed by a third party) is done on a different system. However, such systems may be applications that exist and are carried out in a virtualized cloud environment lacking a physical location.

It is to be appreciated that that the threshold values provided herein are given for example purposes only and that such values may be varied depending on the various requirements and/or constraints of a particular application of the disclosed concept.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A method of managing one or more of the transmission and processing of video signals, the method comprising:
receiving a source video;
determining the perceptual video quality of the source video by performing a non-reference quality analysis on the source video;
determining one of:
that the perceptual video quality of the source video is below a first predetermined threshold;
that the perceptual video quality of the source video is at least the first predetermined threshold but less than a second predetermined threshold; or
that the perceptual video quality of the source video is at least the second predetermined threshold; and
in response to said determining:
compressing a plurality of versions of the source video in accordance with a plurality of corresponding profiles if it is determined that the quality of the source video is at least the second predetermined threshold,
compressing a number of versions of the source video in accordance with a number of corresponding profiles if it is determined that the quality of the source video is at least the first predetermined threshold but less than the second predetermined threshold, wherein the number of copies is less than the plurality of copies, or
performing no compression of the source video if it is determined that the quality of the source video is below a first predetermined threshold.

2. The method of claim 1, further comprising performing another non-reference quality analysis on at least one version of the compressed versions of the source video.

3. The method of claim 2, further comprising determining that the perceptual video quality of the at least one version of the compressed versions of the source video is at least a third threshold and responsive thereto indicating that the at least one version is acceptable to distribute.

4. The method of claim 3, wherein indicating that the at least one version is acceptable to distribute comprises communicating the at least one version to a distributer.

5. The method of claim 3, wherein indicating that the at least one version is acceptable to distribute comprises distributing the at least one version to an end consumer.

6. The method of claim 2, further comprising determining that the perceptual video quality of the at least one version of the compressed versions of the source video is less than a third threshold and responsive thereto performing no further processing of the at least one version.

7. The method of claim 1, further comprising performing another non-reference quality analysis on at least two versions of the compressed versions of the source video.

8. The method of claim 7, further comprising determining that the perceptual video quality of the at least two versions of the compressed versions of the source video are at least a third threshold and are within a predetermined percentage of each other, and responsive thereto, selecting only one of the at least two versions to distribute.

9. The method of claim 8, wherein selecting only one of the at least two versions to distribute comprises selecting the version of the at least two versions having a lower bit rate associated therewith.

10. The method of claim 9, wherein selecting the one version to distribute comprises communicating the one version to a distributer.

11. The method of claim 9, wherein selecting the one version to distribute comprises distributing the at least one version to an end consumer.
